(19) United States
(12) Patent Application Publication
(10) Pub. No.: US 2017/0155120 A1
(43) Pub. Date: Jun. 1, 2017

(54) NONAQUEOUS ELECTROLYTE SECONDARY BATTERY SEPARATOR, NONAQUEOUS ELECTROLYTE SECONDARY BATTERY LAMINATED SEPARATOR, NONAQUEOUS ELECTROLYTE SECONDARY BATTERY MEMBER, AND NONAQUEOUS ELECTROLYTE SECONDARY BATTERY

(71) Applicant: Sumitomo Chemical Company, Limited, Tokyo (JP)

(72) Inventors: Chikae YOSHIMARU, Osaka (JP); Chikara MURAKAMI, Osaka (JP)

(21) Appl. No.: 15/362,882

(22) Filed: Nov. 29, 2016

(30) Foreign Application Priority Data
Nov. 30, 2015 (JP) 2015-233936

(51) Int. Cl. H01M 2/16; H01M 10/0525

(52) U.S. Cl. CPC H01M 2/1686; H01M 10/0525; H01M 2/1653; H01M 2220/30

(57) ABSTRACT

Provided is a nonaqueous electrolyte secondary battery separator including a porous film containing polyolefin as a main component, the nonaqueous electrolyte secondary battery separator having a time until temperature rise cessation with respect to an amount of resin per unit area of 2.9 sec·m²/g to 5.7 sec·m²/g, the time being obtained in a case where the nonaqueous electrolyte secondary battery separator is impregnated with N-methyl pyrrolidine containing 3 wt % water and is subsequently irradiated, at an output of 1,800 W, with a microwave having a frequency of 2,455 MHz, the nonaqueous electrolyte secondary battery separator having an excellent initial rate characteristic and being capable of preventing a deterioration in rate characteristic which deterioration is caused by repeated charge and discharge.

This Nonprovisional application claims priority under 35 U.S.C. §119 on Patent Application No. 2015-233936filed in Japan on Nov. 30, 2015, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”), a laminated separator for a nonaqueous electrolyte secondary battery (hereinafter referred to as a “nonaqueous electrolyte secondary battery laminated separator”), a member for a nonaqueous electrolyte secondary battery (hereinafter referred to as a “nonaqueous electrolyte secondary battery member”), and a nonaqueous electrolyte secondary battery.

### BACKGROUND ART

Nonaqueous electrolyte secondary batteries, such as lithium-ion secondary batteries, each of which has a high energy density, have been widely used as batteries for use in devices such as a personal computer, a mobile phone, and a portable information terminal. These days, efforts are being made to develop nonaqueous electrolyte secondary batteries as automotive-use batteries.

As a separator used for a nonaqueous electrolyte secondary battery such as a lithium-ion secondary battery, a microporous film containing a poly olefin as a main component has been used.

A nonaqueous electrolyte secondary battery has a problem of a deterioration in cycle characteristic thereof. This deterioration occurs for the reasons below. Specifically, an electrode of the battery repeatedly swells and contracts in line with charge and discharge, and thus stress is generated between the electrode and a separator of the battery, This causes an electrode active material to, for example, fall out, and consequently causes an increase in internal resistance. The deterioration in cycle characteristic thus occurs. In order to address the problem, there have been proposed techniques for increasing adhesion between a separator and an electrode by coating a surface of the separator with an adhesive material such as polyvinylidene fluoride (Patent Literatures 1 and 2).

### CITATION LIST

### Patent Literatures

[Patent Literature 1]

Japanese Patent No. 5355823 (Publication date: Nov. 27, 2013)

[Patent Literature 2]

Japanese Patent Application Publication, Tokukai, No. 2001-118558 (Publication date: Apr. 27, 2001)

### SUMMARY OF INVENTION

### Technical Problem

Note, however, that the techniques disclosed in Patent Literatures 1 and 2 each have a problem such that an initial rate characteristic is insufficiently high, or such that repeated charge and discharge cause a deterioration in rate characteristic.

The present invention has been made in view of the problems, and an object of an embodiment of the present invention is to provide a nonaqueous electrolyte secondary battery separator, a nonaqueous electrolyte secondary battery laminated separator, a nonaqueous electrolyte secondary battery member, and a nonaqueous electrolyte secondary battery each of which has an excellent initial rate characteristic and is capable of preventing a deterioration in rate characteristic which deterioration is caused by repeated charge and discharge.

### Solution to Problem

A nonaqueous electrolyte secondary battery separator in accordance with an embodiment of the present invention includes a porous film containing poly olefin as a main component, the nonaqueous electrolyte secondary battery separator having a time until temperature rise cessation with respect to an amount of resin per unit area of 2.9 sec·m²/g to 5.7 sec·m²/g, the time being obtained in a case where the nonaqueous electrolyte secondary battery separator is impregnated with N-methylpyrrolidone containing 3 wt % water and is subsequently irradiated, at an output of 1,800 W, with a microwave having a frequency of 2,455 MHz.

Furthermore, a nonaqueous electrolyte, secondary battery separator in accordance with an embodiment of the present invention is preferably arranged such that the time until temperature rise cessation with respect to an amount of resin per unit area ranges from 2.9 sec·m²/g to 5.3 sec·m²/g.

A nonaqueous electrolyte secondary battery laminated separator in accordance with an embodiment of the present invention includes: a nonaqueous electrolyte secondary battery separator mentioned above; and a porous layer.

A nonaqueous electrolyte secondary battery member in accordance with an embodiment of the present invention includes: a cathode; a nonaqueous electrolyte secondary battery separator mentioned above or a nonaqueous electrolyte secondary battery laminated separator mentioned above; and an anode, the cathode, the nonaqueous electrolyte secondary battery separator or the nonaqueous electrolyte secondary battery laminated separator, and the anode being provided in this order.

A nonaqueous electrolyte secondary battery in accordance with an embodiment of the present invention includes: a nonaqueous electrolyte secondary battery separator mentioned above or a nonaqueous electrolyte secondary battery laminated separator mentioned above.

### Advantageous Effects of Invention

An embodiment of the present invention yields an effect of providing a nonaqueous electrolyte secondary battery separator, a nonaqueous electrolyte secondary battery laminated separator, a nonaqueous electrolyte secondary battery member, and a nonaqueous electrolyte secondary battery each of which has an excellent initial rate characteristic and is capable of preventing a deterioration in rate characteristic which deterioration is caused by repeated charge and discharge.

### DESCRIPTION OF EMBODIMENTS

An embodiment of the present invention is described below. Note, however, that the present invention is not. limited to such an embodiment. The present invention is not limited to arrangements described below, but can be altered by a skilled person in the art within the scope of the claims. An embodiment derived from a proper combination of technical means each disclosed in a different embodiment is also encompassed in the technical scope of the present invention. Note that a numerical range “A to B” herein means “not less than A and not more than B” unless otherwise specified.

### 1. Separator

### (1-1) Nonaqueous Electrolyte Secondary Battery Separator

A nonaqueous electrolyte secondary battery separator in accordance with an embodiment of the present invention includes a porous film that is filmy and is provided between a cathode and an anode of a nonaqueous electrolyte secondary battery.

The porous film only needs to be a base material that is porous and filmy, and contains, as a main component, a polyolefin-based resin (a polyolefin-based porous base material). The porous film is a film that (i) has therein pores connected to one another and (ii) allows a gas or a liquid to pass therethrough from, one surface to the other.

The porous film is arranged such that in a case where the battery generates heat, the porous film, is melted so as to make the nonaqueous electrolyte secondary battery separator non-porous. This allows the porous film to impart a shutdown function to the nonaqueous electrolyte secondary battery separator. The porous film can be made of a single layer or a plurality of layers.

Inventors accomplished the present invention by finding, for the first time, that (a) a time until a temperature of the porous film ceases rising (time until temperature rise cessation), the time being obtained in a case where the porous film is impregnated with N-methylpyrrolidone containing 3 wt % water and is subsequently irradiated, at an output of 1800 W, with, a microwave having a frequency of 2455 MHz is associated with (to) an Initial rate characteristic of the battery and (c) a deterioration in rate characteristic after repeated charge and discharge of the battery.

A nonaqueous electrolyte secondary battery which is charged and discharged causes an electrode thereof to swell. Specifically, an anode of the nonaqueous electrolyte secondary battery swells during the charge of the nonaqueous electrolyte secondary battery, and a cathode of the nonaqueous electrolyte secondary battery swells during the discharge of the nonaqueous electrolyte secondary battery. This causes an electrolyte solution in the nonaqueous electrolyte secondary battery separator to be pushed from the swelling electrode side toward the opposite electrode side. Such a mechanism causes the electrolyte solution to move through the nonaqueous electrolyte secondary battery separator during a charge and discharge cycle. Note here that since the nonaqueous electrolyte secondary battery separator has pores as described earlier, the electrolyte solution moves through, the pores.

Movement of the electrolyte solution through the pores of the nonaqueous electrolyte secondary battery separator is accompanied by stress that acts on a wall surface of each of the pores. A strength of the stress is associated with a pore structure, i.e., a capillary force in pores connected to one another and an area of a pore wall. Specifically, a stronger capillary force and a greater area of a pore wall are considered to cause a greater stress to act on the pore wall. Furthermore, the strength of the stress, which strength is also associated with an amount of the electrolyte solution moving through the pores, is considered to be increased in a case where a greater amount of the electrolyte solution moves, i.e., in a case where the battery is operated under a condition of a large current. The increase in stress causes a wall surface of a pore to change in shape so as to block the pore. This causes the battery to have a lower output characteristic. Thus, the battery which is repeatedly charged and discharged and/or which is operated under a condition of a large current gradually has a lower rate characteristic.

The electrolyte solution which is pushed out from the nonaqueous electrolyte secondary battery separator in a small amount causes (i) a reduction in an amount of the electrolyte solution per unit surface area of an electrode surface or (ii) local depletion of the electrolyte solution on the electrode surface. This may bring about an increase in generation of an electrolyte solution decomposition product. Such an electrolyte solution decomposition product causes the nonaqueous electrolyte secondary battery to have a lower rate characteristic.

As described earlier, (i) a pore structure (a capillary force in pores and an area of a pore wall) of the nonaqueous electrolyte secondary battery separator and (ii) a capability of the nonaqueous electrolyte secondary battery separator to supply the electrolyte solution to an electrode are associated with a deterioration in rate characteristic which deterioration, occurs in (a) a case where the battery is repeatedly charged and discharged and/or (b) a case where the battery is operated under a condition of a large current. In light of this issue, the inventors of the present invention focused on a temperature change that occurs in a case where the porous film is impregnated with N-methylpyrrolidone containing 3 wt % water and is subsequently irradiated, at an output of 1800 W, with a microwave having a frequency of 2455 MHz.

A porous film that contains N-methylpyrrolidone containing water and is irradiated with a microwave generates heat by vibrational energy of the water. The heat thus generated is transferred to resin of the porous film, with which resin the N-methylpyrrolidone containing the water is in contact. Temperature rise ceases when equilibrium is reached between a rate of heat generation and a rate of cooling caused by heat transfer to the resin. Because of this, a time until temperature rise ceases (time until temperature rise cessation) is associated with a degree of contact between (i) liquid contained in the porous film (here, the N-methylpyrrolidone containing water) and (ii) the resin of which the porous film is made. Note that this degree of contact is closely associated with a capillary force in pores of the porous film and an area of a pore wall. This makes it possible to use the time until temperature rise cessation to evaluate a pore structure of the porous film (a capillary force in pores and an area of a pore wall). Specifically, a shorter time until temperature rise cessation indicates a greater capillary force in the pores and a greater area of the pore wall.

Greater ease of movement of the liquid through the pores of the porous film seems to bring (i) liquid contained in the porous film and (ii) resin of which the porous film is made into contact with each other with a greater degree. This makes it possible to use the time until temperature rise cessation to evaluate the capability of the nonaqueous electrolyte secondary battery separator to supply the electrolyte solution to the electrode. Specifically, a shorter time until temperature rise cessation indicates a greater capability of the nonaqueous electrolyte secondary battery separator to supply the electrolyte solution to the electrode.

A porous film in accordance with an embodiment of the present invention has a time until temperature rise cessation with respect to an amount, of resin per unit area (mass per unit area) of 2.9 sec·m²/g to 5.7 sec·m²/g, preferably of 2.9 sec·m²/g to 5.3 sec·m²/g.

The porous film which has a time until temperature rise cessation with respect to an amount of resin per unit area of less than 2.9 sec·m²/g causes each of a capillary force in pores of the porous film and an area of a pore wall to be too great. In such a case, pores are blocked due to an increase in stress that acts on the pore wall when an electrolyte solution moves through the pores during a charge and discharge cycle and/or during operation of a battery under a condition of a large current. This causes the battery to have a lower output characteristic.

The porous film which has a time until temperature rise cessation with respect to an amount of resin per unit area of more than 5.7 sec·m²/g makes it difficult for liquid to move through pores of the porous film. Further, the porous film which is used as the nonaqueous electrolyte secondary battery separator causes the electrolyte solution to move slowly near an interface between the porous film and an electrode of the battery. This causes the battery to have a lower rate characteristic. Furthermore, repeated charge and discharge of the battery cause the electrolyte solution to be easily locally depleted on the separator-electrode interface and in the porous film. This causes an increase in resistance in the battery and causes the nonaqueous electrolyte secondary battery to have a lower rate characteristic after the charge and discharge cycle.

In contrast to the above, the porous film which has a time until temperature rise cessation with respect to an amount of resin per unit area of 2.9 sec·m²/g to 5.7 sec·m²/g makes it possible to achieve an excellent initial rate characteristic and prevent a deterioration in rate characteristic after a charge and discharge cycle (see Examples described later).

The porous film can have any thickness that is appropriately set in view of a thickness of a nonaqueous electrolyte secondary battery member of the nonaqueous electrolyte secondary battery. The porous film has a thickness preferably of 4 μm to 40 μm, more preferably of 5 μm to 30 μm, and still more preferably of 6 μm to 20 μm.

The porous film has a volume-based porosity of 20 vol % to 80 vol %, and preferably 30 vol % to 75 vol %, in order to allow the non-aqueous secondary battery separator to (i) retain a larger amount of electrolyte solution and (ii) achieve a function of reliably preventing (shutting down) a flow of an excessively large current at a lower temperature. The porous film has pores having an average diameter (an average pore diameter) of preferably 0.30 μm or less, more preferably 0.14 μm or less, in order to, in a case where the porous film is used as a separator, achieve sufficient ion permeability and prevent particles from entering the cathode or the anode.

It is essential that the porous film contains a polyolefin component at a proportion of 50% by volume or more with respect to whole components contained in the porous film. Such a proportion of the polyolefin component is preferably 90% by volume or more, and more preferably 95% by volume or more. The porous film preferably contains, as the polyolefin component, a high molecular weight component having a weight-average molecular weight of 5×10⁵ to 15×10⁶. The porous film particularly preferably contains, as the polyolefin component, a polyolefin component having a weight-average molecular weight of 1,000,000 or more. This is because the porous film which contains such a polyolefin component allows the porous film and the entire nonaqueous electrolyte secondary battery separator to have a greater strength.

Examples of the polyolefin-based resin constituting the porous film include high molecular weight homopolymers or copolymers produced through polymerization of ethylene, propylene, 1-butene, 4-methyl-1-pentene, 1-hexene, and/or the like. The porous film can include a layer containing only one of these polyolefin-based resins and/or a layer containing two or more of these polyolefin-based resins. Among these, a high molecular weight polyethylene containing ethylene as a main component is particularly preferable. Note that the porous film can contain a non-polyolefin component, as long as the non-polyolefin component does not impair the function of the layer.

Examples of the polyethylene-based resin include low-density polyethylene, high-density polyethylene, linear polyethylene (an ethylene-α-olefin, copolymer), ultra-high molecular weight polyethylene having a weight-average molecular weight of not less than 1,000,000, and the like. Of these polyethylene-based resins, ultra-high molecular weight polyethylene having a weight-average molecular weight of not less than 1,000,000 is particularly preferable.

The porous film has normally an air permeability in a range from 30 sec/100 cc to 700 sec/100 cc, and preferably in a range from 40 sec/100 cc to 400 sec/100 cc, in terms of Gurley values. A porous film having such an air permeability achieves sufficient ion permeability in a case where the porous film is used as a separator.

The porous film, has a mass per unit area of preferably 4 g/m² to 20 g/m², more preferably 4 g/m² to 12 g/m², and still more preferably 5 g/m² to 12 g/m², because such a mass per unit area of the porous film can increase (i) a strength, a thickness, handling easiness, and a weight of the porous film and (ii) a weight energy density and a volume energy density of a nonaqueous electrolyte secondary battery including the porous film as a nonaqueous electrolyte secondary battery separator.

The following description discusses a method for producing the porous film. The porous film which contains a polyolefin-based resin as a main component, e.g., the porous film which is made of polyolefin resin containing (i) ultra-high molecular weight polyethylene and (ii) low molecular weight polyolefin having a weight-average molecular weight of not more than 10,000 is preferably produced by such a method as described below.

Specifically, the porous film can be obtained by a method including the steps of (1) obtaining a polyolefin resin composition by kneading (i) ultra-high molecular weight polyethylene (ii) low molecular weight polyolefin having a weight-average molecular weight of not more than 10,000, and (iii) a pore forming agent such as calcium carbonate or a plasticizing agent, (2) forming (rolling) a sheet by using a reduction roller to roll the polyolefin resin composition obtained in the step (1), (3) removing the pore forming agent from the sheet obtained in the step (2), and (4) obtaining a porous film by stretching the sheet, obtained in the step (3).

Note here that a pore structure of the porous film (a capillary force in pores, aft area of a pore wall, residual stress in the porous film) is affected by a strain rate during the stretching in the step (4) and a temperature per unit thickness of a stretched film at which temperature a heat fixation treatment (annealing treatment) is carried out after stretching (heat fixation temperature per unit thickness of stretched film). This makes it possible to control (i) the pore structure of the porous film and (ii) the time until temperature rise cessation with respect to an amount of resin per unit area by adjusting the strain rate and the heat fixation temperature per unit thickness of the stretched film.

Specifically, the porous film of an embodiment of the present invention tends to be obtained in a case where the strain rate and the heat fixation temperature per unit thickness of the stretched film are adjusted to fall within a range that is defined by a triangle whose three vertices are located at (500% per minute, 1.5° C./μm), (900% per minute, 14.0° C./μm), and (2500% per minute, 11.0° C./μm), respectively, on a graph where an x-axis shows the strain rate and a y-axis shows the heat setting temperature per unit thickness of the stretched film. The strain rate and the heat fixation temperature per unit thickness of the stretched film are preferably adjusted to fall within a range that is defined by a triangle whose three vertices are located at (600% per minute, 5.0° C./μm), (900% per minute, 12.5° C./μm), and (2500% per minute, 11.0° C./μm), respectively, on the above graph.

### (1-2) Nonaqueous Electrolyte Secondary Battery Laminated Separator

In another embodiment of the present invention, it is possible to use, as a separator, a nonaqueous electrolyte secondary battery laminated separator that includes (i) the nonaqueous electrolyte secondary battery separator (described earlier), which includes a porous film, and (ii) publicly known porous layer(s) such as an adhesive layer, a heat-resistant layer, and/or a protective layer.

A porous film on which a porous layer is to be formed is preferably subjected to a hydrophilization treatment before a coating solution described below is applied thereto. Performing a hydrophilization treatment on the porous film further improves coating easiness of the coating solution and thus allows a more uniform porous layer to be formed. This hydrophilization treatment is effective in a case where a solvent (disperse medium) contained in the coating solution has a high proportion of water.

Specific examples of the hydrophilization treatment include publicly known treatments such as (i) a chemical treatment involving an acid, an alkali, or the like, (ii) a corona treatment, and (iii) a plasma treatment. Among these hydrophilization treatments, a corona treatment is preferable because it can not only hydrophilize the porous film within a relatively short time period, but also hydrophilize only a surface and its vicinity of the porous film to leave the inside of the porous film unchanged in quality.

The porous layer is appropriately laminated to one side or both sides of the nonaqueous electrolyte secondary battery separator, which is the porous film. It is preferable that a resin of which the porous layer is made be insoluble in an electrolyte of a battery and be electrochemically stable in a range of use of the battery. The porous layer that is laminated to one side of the porous film is preferably laminated to a surface of the porous film which surface faces a cathode of a nonaqueous electrolyte secondary battery which includes the laminated separator, and is more preferably laminated to a surface of the porous film which surface is in contact with the cathode.

Specific examples of the resin of which the porous layer is made include; polyolefins such as polyethylene, polypropylene, polybutene, and an ethylene-propylene copolymer; fluorine-containing resins such as polyvinylidene fluoride (PVDP) and polytetrafluoroethylene; fluorine-containing rubbers such as a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; aromatic polyamide; wholly aromatic polyamide (aramid resin); rubbers such as a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate; resins having a melting point or a glass transition temperature of not less than 180° C., such as polyphenylene ether, polysulfone, polyether sulfone, polyphenylene sulfide, polyetherimide, polyamide-imide, polyether amide, and polyester; water-soluble polymers such as polyvinyl alcohol, polyethylene glycol, cellulose ether, sodium alginate, polyacrylic acid, polyacrylamide, and polymethacrylic acid; and the like.

Specific examples of the aromatic polyamides include poly(paraphenylene terephthalamide), poly(methaphenylene isophthalamide), poly(parabenzamide), poly(methabenzamide), poly(4,4′-benzanilide terephthalamide), poly(paraphenylene-4,4′-biphenylene dicarboxylic amide), poly(methaphenylene-4,4′-biphenylene dicarboxylic amide), poly (paraphenylene-2,6-naphthalene dicarboxylic amide), poly(methaphenylene-2,6-naphthalene dicarboxylic amide), poly(2-chloroparaphenylene terephthalamide), a paraphenylene terephthalamide/2,6-dichloroparaphenylene terephthalamide copolymer, and a methaphenylene terephthalamide/2,6-dichloroparaphenylene terephthalamide copolymer. Out of these aromatic polyamides, poly(paraphenylene terephthalamide) is more preferable.

Out of the above resins, a polyolefin, a fluorine-containing resin, an aromatic polyamide, or a water-soluble polymer is more preferable. In a case where the porous layer is provided so as to face a cathode of a nonaqueous electrolyte secondary battery, a fluorine-containing resin is particularly preferable.

A porous layer containing a fluorine-containing resin is highly adhesive to an electrode and functions as an adhesive layer. A water-soluble polymer, which allows water to be used as a solvent to form the porous layer, is preferable in terms of process facilitation and environmental burden reduction. A porous layer containing aromatic polyamide is highly heat-resistant and functions as a heat-resistant layer.

The porous layer can contain a filler, which is electrically insulating fine particles. Examples of the filler which can be contained in the porous layer include a filler made of an organic matter and a filler made of an inorganic matter. Specific examples of the filler made of an organic matter include fillers made of (i) a homopolymer of a monomer such as styrene, vinyl ketone, acrylonitrile, methyl methacrylate, ethyl methacrylate, glycidyl methacrylate, glycidyl acrylate, or methyl acrylate, or (ii) a copolymer of two or more of such monomers; fluorine-containing resins such as polytetrafluoroethylene, an ethylene tetrafluoride-propylene hexafluoride copolymer, a tetrafluoroethylene-ethylene copolymer, and polyvinylidene fluoride; melamine resin; urea resin: polyethylene; polypropylene; polyacrylic acid and polymethacrylic acid; and the like. Specific examples of the filler made of an inorganic matter include fillers, made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. The porous layer can contain (i) only one kind of filler or (ii) two or more kinds of fillers in combination.

Among the above fillers, a filler made of an inorganic matter is suitable. A filler made of an inorganic oxide such as silica, calcium oxide, magnesium oxide, titanium oxide, alumina, mica, zeolite, aluminum hydroxide, or boehmite is preferable. A filler made of at least one kind selected from the group consisting of silica, magnesium oxide, titanium oxide, and alumina is more preferable. A filler made of alumina is particularly preferable. Alumina has many crystal forms such as α-alumina, β-alumina, γ-alumina, and θ-alumina, and any of the crystal forms can be suitably used. Among the above crystal forms, α-alumina, which is particularly high in thermal stability and chemical stability, is the most preferable.

The filler has a shape that varies depending on, for example, (i) a method for producing the organic matter or inorganic matter as a raw material and (ii) a condition under which the filler is dispersed during preparation of a coating solution for forming the porous layer. The filler can have any of various shapes such as a spherical shape, an oblong shape, a rectangular shape, a gourd shape, and an indefinite irregular shape.

In a case where the porous layer contains a filler, the filler is contained in an amount preferably of 1% by volume to 99% by volume and more preferably of 5% by volume to 95% by volume of the porous layer. The filler which is contained in the porous layer in an amount falling within the above range makes it less likely for a void formed by a contact among fillers to be blocked by, for example, a resin. This makes it possible to obtain sufficient ion permeability and to set a mass per unit area of the porous layer at an appropriate value.

As a method for producing a coating solution for forming the porous layer by dissolving the resin in a solvent and dispersing the filler, the solvent, (dispersion medium), which is not particularly limited to any specific solvent, only needs to (i) have no harmful influence on the porous film, (ii) uniformly and stably dissolve the resin, and (iii) uniformly and stably disperse the filler. Specific examples of the solvent (dispersion medium) include: water; lower alcohols such as methyl alcohol, ethyl alcohol, n-propyl alcohol, isopropyl alcohol, and t-butyl alcohol; acetone, toluene, xylene, hexane, N-methylpyrrolidone, N,N-dimethylacetamide, and N,N-dimethylformamide; and the like. The above solvents (dispersion media) can be used in only one kind or in combination of two or more kinds.

The coating solution can foe formed by any method provided that, the coating solution can meet conditions such as a resin solid content (resin concentration) and a filler amount each necessary for obtainment of a desired porous layer. Specific examples of a method for forming the coating: solution, include a mechanical stirring method, an ultrasonic dispersion method, a high-pressure dispersion method, a media dispersion method, and the like.

Further, the filler can be dispersed in the solvent (dispersion medium) by use of, for example, a conventionally publicly known dispersing machine such as a three-one motor, a homogenizer, a media dispersing machine, or a pressure dispersing machine. Furthermore, it is possible to prepare a coating solution concurrently with wet grinding carried out so as to obtain a filler having a desired average particle diameter. The preparation of the coating solution concurrently with the wet grinding of the filler can be carried out by supplying (i) a liquid in which a resin is dissolved or swollen or (ii) a resin emulsion to a wet grinding apparatus during the wet grinding. That is, wet grinding of a filler and preparation of a coating solution can be concurrently carried out in a single step.

In addition, the coating solution can contain, as a component different from the resin and the filler, additive(s) such as a disperser, a plasticizer, a surfactant, and/or a pH adjustor, provided that the additive(s) does/do not impair the object of the present invention. Note that the additive(s) can be contained in an amount that does not impair the object of the present invention.

A method for applying the coating solution to the porous film, i.e., a method for forming the porous layer on a surface of the porous film which has been appropriately subjected to a hydrophilization treatment is not particularly restricted. In a case where the porous layer is laminated to both sides of the porous film, (i) a sequential lamination method in which the porous layer is formed on one side of the porous film and then the porous layer is formed on the other side of the porous film, or (ii) a simultaneous lamination method in which the porous layer is formed simultaneously on both sides of the porous film is applicable to the case.

Examples of a method for forming the porous layer include: a method in which the coating solution is directly applied to the surface of the porous film and then the solvent (dispersion medium) is removed; a method in which the coating solution is applied to an appropriate support, the porous layer is formed by removing the solvent (dispersion medium), and thereafter the porous layer thus formed and the porous film are pressure-bonded and subsequently the support is peeled off; a method in which the coating solution is applied to the appropriate support and then the porous film is pressure-bonded to an application surface, and subsequently the support is peeled off and then the solvent (dispersion medium) is removed; a method in which the porous film is immersed in the coating solution so as to be subjected to dip coating, and thereafter the solvent (dispersion medium) is removed; and the like.

The porous layer can have a thickness that is controlled by adjusting, for example, a thickness of a coated film that is moist (wet) after being coated, a weight ratio between the resin and the fine particles, and/or a solid content concentration (a sum of a resin concentration and a fine particle concentration) of the coating solution. Note that it is possible to use, as the support, a film made of resin, a belt made of metal, or a drum, for example.

A method for applying the coating solution to the porous film or the support is not particularly limited to any specific method provided that the method achieves a necessary mass per unit area and a necessary coating area. The coating solution can be applied to the porous film or the support by a conventionally publicly known method. Specific examples of the conventionally publicly known method include a gravure coater method, a small-diameter gravure coater method, a reverse roll coater method, a transfer roll coater method, a kiss coater method, a dip coater method, a knife coater method, an air doctor blade coater method, a blade coater method, a rod coater method, a squeeze coater method, a cast coater method, a bar coater method, a die coater method, a screen printing method, a spray application method, and the like.

Generally, the solvent (dispersion medium) is removed by drying. Examples of a drying method include natural drying, air-blowing drying, heat, drying, vacuum drying, and the like. Note, however, that any drying method is usable provided that the drying method allows the solvent (dispersion medium) to be sufficiently removed. For the drying, it is possible to use an ordinary drying device.

Further, it is possible to carry out the drying after replacing, with another solvent, the solvent (dispersion medium) contained in the coating solution. Examples of a method for removing the solvent (dispersion medium) after replacing the solvent (dispersion medium) with another solvent include a method in which another solvent (hereinafter referred to as a solvent X) is used that is dissolved in the solvent (dispersion medium) contained in the coating solution and does not dissolve the resin contained in the coating solution, the porous film or the support on which a coated film has been formed by application of the coating solution is immersed in the solvent X, the solvent (dispersion medium) contained in the coated film formed on the porous film or the support is replaced with the solvent X, and thereafter the solvent X is evaporated. This method makes it possible to efficiently remove the solvent (dispersion medium) from the coating solution.

Assume that heating is carried out so as to remove the solvent (dispersion medium) or the solvent X from the coated film of the coating solution which coated film has been formed on the porous film or the support. In this case, in order to prevent the porous film from having a lower air permeability due to contraction of pores of the porous film, it is desirable to carry out heating at a temperature at which the porous film does not have a lower air permeability, specifically, 10° C. to 120° C., more preferably 20° C. to 80° C.

In a case where the porous film is used as the base material to form the nonaqueous electrolyte secondary battery laminated separator by laminating the porous layer to one side or both sides of the porous film, the porous layer formed by the method described earlier has, per one side thereof, a film thickness preferably of 0.5 μm to 15 μm and more preferably of 2 μm to 10 μm.

The porous layer whose both sides have a film thickness of less than 1 μm in total and which is used in the nonaqueous electrolyte secondary battery makes it impossible to satisfactorily prevent an internal short circuit caused by, for example, damage to the nonaqueous electrolyte secondary battery. Furthermore, such a porous layer causes a lower amount of an electrolyte solution to be retained in the porous layer.

Meanwhile, the porous layer whose both sides have a film thickness of more than 30 μm in total and which is used in the nonaqueous electrolyte secondary battery causes an increase in permeation resistance of lithium ions in the entire nonaqueous electrolyte secondary battery laminated separator. Thus, in a case where charge and discharge cycles are repeated, the cathode of the nonaqueous electrolyte secondary battery deteriorates, and the nonaqueous electrolyte secondary battery has a lower rate characteristic and/or a lower cycle characteristic. Furthermore, such a porous layer, which increases a distance between the cathode and the anode, makes the nonaqueous electrolyte secondary battery larger in size.

In a case where the porous layer is laminated to both sides of the porous film, physical properties of the porous layer which are described below at least refer to physical properties of the porous layer which is laminated to a surface of the porous film which surface faces the cathode of the nonaqueous electrolyte secondary battery which includes the porous film.

The porous layer, which only needs to have, per one side thereof, a mass per unit area which mass is appropriately determined in view of a strength, a film, thickness, a weight, and handleability of the nonaqueous electrolyte secondary battery laminated separator, normally has a mass per unit area preferably of 1 g/m² to 20 g/m³ and more preferably of 2 g/m² to 10 g/m²,

The porous layer which has a mass per unit area which mass falls within the above range allows an increase in weight energy density and volume energy density of the nonaqueous electrolyte secondary battery which includes the porous layer. Meanwhile, the porous layer which has a mass per unit area which mass is beyond the above range causes the nonaqueous electrolyte secondary battery which includes the nonaqueous electrolyte secondary battery laminated separator to be heavy.

The porous layer has a porosity preferably of 20% by volume to 90% by volume and more preferably of 30% by volume to 80% by volume so as to achieve sufficient ion permeability. The porous layer has pores having a pore diameter preferably of not more than 1 μm and more preferably of not more than 0.5 μm. The porous layer whose pores are set to have a pore diameter failing within, the above range allows the nonaqueous electrolyte secondary battery which includes the nonaqueous electrolyte secondary battery laminated separator which includes the porous layer to achieve sufficient ion permeability.

The nonaqueous electrolyte secondary battery laminated separator has a Gurley air permeability preferably of 30 sec/100 ml to 1000 sec/100 mL and more preferably of 50 sec/100 mL to 800 sec/100 mL. The nonaqueous electrolyte secondary battery laminated separator which has a Gurley air permeability falling within the above range makes it possible to obtain sufficient ion permeability in a case where the nonaqueous electrolyte secondary battery laminated separator is used as a member for the nonaqueous electrolyte secondary battery.

Meanwhile, the nonaqueous electrolyte secondary battery laminated separator which has a Gurley air permeability beyond the above range means that the separator has a coarse laminated structure due to a high porosity thereof. This causes the separator to have a lower strength, so that the separator may be insufficient in shape stability, particularly shape stability at a high temperature. In contrast, the nonaqueous electrolyte secondary battery laminated separator which has a Gurley air permeability falling below the above range makes it impossible to obtain sufficient ion permeability in a case where the separator is used as a member for the nonaqueous electrolyte secondary battery. This may cause the nonaqueous electrolyte secondary battery to have a lower battery characteristic.

### 2. Nonaqueous Electrolyte Secondary Battery Member, Nonaqueous Electrolyte Secondary Battery

A nonaqueous electrolyte secondary battery member in accordance with an embodiment of the present invention is a nonaqueous electrolyte secondary battery member including a cathode, a nonaqueous electrolyte secondary battery separator or a nonaqueous electrolyte secondary battery laminated separator, and an anode that are provided in this order. A nonaqueous electrolyte secondary battery in accordance with an embodiment of the present invention includes a nonaqueous electrolyte secondary battery separator or a nonaqueous electrolyte secondary battery laminated separator. The following description is given by (i) taking a lithium ion secondary battery member as an example of the nonaqueous electrolyte secondary battery member and (ii) taking a lithium ion secondary battery as an example of the nonaqueous electrolyte secondary battery. Note that components of the nonaqueous electrolyte secondary battery member or the nonaqueous electrolyte secondary battery except the nonaqueous electrolyte secondary battery separator or the nonaqueous electrolyte secondary battery laminated separator are not limited to those discussed in the following description.

In the nonaqueous electrolyte secondary battery in accordance with an embodiment of the present invention, it is possible to use, for example, a nonaqueous electrolyte obtained by dissolving lithium salt in an organic solvent. Examples of the lithium salt, include LiClCO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, LiAlCl₄, and the like. The above lithium salts can be used in only one kind or in combination of two or more kinds. Of the above lithium salts, at least, one kind of fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃ is more preferable.

Specific examples of the organic solvent of the nonaqueous electrolyte include: carbonates such as ethylene carbonate, propylene carbonate, dimethyl carbonate, diethyl carbonate, ethyl methyl carbonate, 4-trifluoromethyl-1,3-dioxolane-2-one, and 1,2-di(methoxycarbonyloxy)ethane; ethers such as 1,2-dimethoxyethane, 1,3-dimethoxypropane, pentafluoropropylmethyl ether, 2,2,3,3-tetrafluoropropyldifluoromethyl ether, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethylsulfoxide, and 1,3-propanesultone; a fluorine-containing organic solvent obtained by introducing a fluorine group in the organic solvent; and the like. The above organic solvents can be used in only one kind or in combination of two or more kinds. Of the above organic solvents, a carbonate is more preferable, and a mixed solvent of cyclic carbonate and acyclic carbonate or a mixed solvent of cyclic carbonate and an ether is more preferable. The mixed solvent of cyclic carbonate and acyclic carbonate is more preferably exemplified by a mixed solvent containing ethylene carbonate, dimethyl carbonate, and ethyl methyl carbonate. This is because the mixed solvent containing ethylene carbonate, dimethyl carbonate, and ethyl methyl carbonate operates in a wide temperature range, and is refractory also in a case where a graphite material such as natural graphite or artificial graphite is used as an anode active material.

Normally, a sheet cathode in which a cathode current collector supports thereon a cathode mix containing a cathode active material, an electrically conductive material, and a binding agent is used as the cathode.

Examples of the cathode active material include a material that is capable of doping and dedoping lithium ions. Specific examples of such a material include lithium complex oxides each containing at least one kind of transition metal selected from the group consisting of V, Mn, Fe, Co, and Ni. Of the above lithium complex oxides, a lithium complex oxide having an α-NaFeO₂ structure, such as lithium nickel oxide or lithium cobalt oxide, or a lithium complex oxide having a spinel structure, such as lithium manganate spinel is more preferable. This is because such a lithium complex oxide is high in average discharge potential. The lithium complex oxide can contain various metallic elements, and lithium nickel complex oxide is more preferable. Further, it is particularly preferable to use lithium nickel complex oxide which contains at least one kind of metallic element so that the at least one kind of metallic element accounts for 0.1 mol % to 20 mol % of a sum of the number of moles of the at least one kind of metallic element and the number of moles of Ni in lithium nickel oxide, the at least one kind of metallic element being selected from the group consisting of Ti, Zr, Ce, Y, V, Cr, Ma, Fe, Co, Cu, Ag, Mg, Al, Ga, In, and Sn. This is because such lithium nickel complex oxide is excellent in cycle characteristic during use of the nonaqueous electrolyte secondary battery at a high capacity. Especially an active material which contains Al or Mn and has an Ni content of not less than 85% and more preferably of not less than 90% is particularly preferable. This is because such an active material is excellent in cycle characteristic during use of the nonaqueous electrolyte secondary battery at a high capacity, the nonaqueous electrolyte secondary battery including the cathode containing the active material.

Examples of the electrically conductive material Include carbonaceous materials such as natural graphite, artificial graphite, cokes, carbon black, pyrolytic, carbons, carbon fiber, organic high molecular compound baked bodies, and the like. The above electrically conductive materials can be used in only one kind. Alternatively, the above electrically conductive materials can be used in combination of two or more kinds by, for example, mixed use of artificial graphite and carbon black.

Examples of the binding agent, include polyvinylidene fluoride, a vinylidene fluoride copolymer, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, and a vinylidene fluoride-vinyl fluoridecopolymer, a vinylidene fluoride-hexafluoropropylene-tetrafluoroethylene copolymer, thermoplastic resins such as thermoplastic polyimide, thermoplastic polyethylene, and thermoplastic polypropylene, acrylic resin, and styrene butadiene rubber. Note that the binding agent also functions as a thickener.

The cathode mix can be obtained by, for example, pressing the cathode active material, the electrically conductive material, and the binding agent on the cathode current collector, or causing the cathode active material, the electrically conductive material, and the binding agent to be in a form of paste by use of an appropriate organic solvent.

Examples of the cathode current collector include electrically conductive materials such as Al, Ni, and stainless steel, and Al, which is easy to process into a thin film and less expensive, is more preferable.

Examples of a method for producing the sheet cathode, i.e., a method for causing the cathode current collector to support the cathode mix include; a method in which the cathode active material, the electrically conductive material, and the binding agent which are to be formed into the cathode mix are pressure-molded on the cathode current collector; a method in which the cathode current collector is coated with the cathode mix which has been obtained by causing the cathode active material, the electrically conductive material, and the binding agent to be in a form of paste by use of an appropriate organic solvent, and a sheet cathode mix obtained by drying is pressed so as to be closely fixed to the cathode current collector; and the like.

Normally, a sheet anode in which an anode current collector supports thereon an anode mix containing an a node active material is used as the anode. The sheet anode preferably contains the electrically conductive material and the binding agent.

Examples of the anode active material include a material that is capable of doping and dedoping lithium ions, lithium metal or lithium alloy, and the like. Specific examples of such a material include: carbonaceous materials such as natural graphite, artificial graphite, cokes, carbon black, pyrolytic carbons, carbon fiber, and organic high molecular compound baked bodies; chalcogen compounds such as oxides and sulfides each doping and dedoping lithium ions at a lower potential than that of the cathode; metals such as aluminum (Al), lead (Pb), tin (Sn), bismuth (Bi), and silicon (Si) each alloyed with an alkali metal; cubic intermetallic compounds (AlSb, Mg₂Si, NiSi₂) having lattice spaces in which alkali metals can be provided; lithium nitrogen compounds (Li₃₋ₓMₓN (M: transition metal)); and the like. Of the above anode active materials, a carbonaceous material which contains, as a main component, a graphite material such as natural graphite or artificial graphite is preferable. This is because such a carbonaceous material is high in potential evenness, and a great energy density can be obtained in a case where the carbonaceous material, which is low in average discharge potential, is combined with the cathode. An anode active material which is a mixture of graphite and silicon and has an Si to C ratio of not less than 5% is more preferable, and an anode active material which is a mixture of graphite and silicon and has an Si to C ratio of not less than 10% is still more preferable.

The anode mix can be obtained by, for example, pressing the anode active material on the anode current collector, or causing the anode active material to be in a form of paste by use of an appropriate organic solvent.

Examples of the anode current collector include Cu, Ni, stainless steel, and the like, and Cu, which is difficult to alloy with lithium particularly in a lithium ion secondary battery and easy to process into a thin film, is more preferable.

Examples of a method for producing the sheet anode, i.e., a method for causing the anode current collector to support the anode mix include: a method in which the anode active material to be formed into the anode mix is pressure-molded on the anode current collector; a method in which the anode current, collector is coated with the anode mix which has been obtained by causing the anode active material to be in a form of paste by use of an, appropriate organic solvent, and a sheet anode mix obtained by drying is pressed so as to be closely fixed to the anode current collector; and the like. The paste preferably contains the electrically conductive material and the binding agent.

The nonaqueous electrolyte secondary battery member in accordance with an embodiment of the present invention is formed by providing the cathode, the nonaqueous electrolyte secondary battery separator or the nonaqueous electrolyte secondary battery laminated separator, and the anode in this order. Thereafter, the nonaqueous electrolyte secondary battery member is placed in a container serving as a housing of the nonaqueous electrolyte secondary battery. Subsequently, the container is filled with a nonaqueous electrolyte, and then the container is sealed while being decompressed. The nonaqueous electrolyte secondary battery in accordance with an embodiment of the present invention can thus be produced. The nonaqueous electrolyte secondary battery, which is not particularly limited in shape, can have any shape such as a sheet (paper) shape, a disc shape, a cylindrical shape, or a prismatic shape such as a rectangular prismatic shape. Note that a method for producing the nonaqueous electrolyte secondary battery is not particularly limited to any specific method, and a conventionally publicly known production method can be employed as the method.

### EXAMPLES

### Method for Measuring Various Physical Properties

Various physical properties of nonaqueous electrolyte secondary battery separators in accordance with the following Examples and Comparative Examples were measured by the method below.

### (1) Time Until Temperature Rise Cessation in Case of Microwave Irradiation

A test piece measuring 8 cm×8 cm was cut out from a nonaqueous electrolyte secondary battery separator, and a weight W (in grams) of the test piece was measured. Thereafter, mass per unit area was calculated based on the following equation: Mass per unit area (g/m²)=W/(0.08×0.08)

Next, the test piece was impregnated with N-methylpyrrolidone (NMP) containing 3 wt % water. Thereafter, the test piece was spread out on a Teflon (registered trademark) sheet (size: 12 cm×10 cm) and then folded in half so that an optical fiber thermometer (“Neoptix Reflex thermometer,” manufactured by Astec Co., Ltd.) coated with polytetrafluoroethylene (PTFE) was provided in the sheet thus folded.

Next, the test piece, which had been impregnated with the water-containing NMP and in which the thermometer was provided, was fixed in a microwave irradiation apparatus including a turntable (9 kW microwave oven manufactured by Micro Denshi Co., Ltd. and having a frequency of 2455 MHz), and the test piece was irradiated with a microwave at 1800 W for two minutes.

A change in temperature of the test piece which change occurred after the microwave irradiation was started was measured at intervals of 0.2 seconds by use of the optical fiber thermometer. In this measurement, a temperature at which temperature rise ceased for one second or longer was regarded as a temperature rise cessation temperature, and a time until the temperature rise cessation temperature was reached after the microwave irradiation was started was regarded as a time until temperature rise cessation. The time until temperature rise cessation thus obtained was divided by the mass per unit area (described earlier) so as to calculate a time until temperature rise cessation with respect to an amount of resin per unit area.

### (2) Initial Rate Characteristic

Nonaqueous electrolyte secondary batteries each assembled as described later were each subjected to four cycles of initial charge and discharge. Each of the four cycles of the initial charge and discharge was carried out at 25° C., at. a voltage ranging from 4.1 V to 2.7 V, and at an electric current value of 0.2 C. Note that a value of an electric current at which a battery rated capacity defined as a one-hour rate discharge capacity is discharged in one hour is assumed to be 1 C. This applies also to the following descriptions.

The nonaqueous electrolyte secondary batteries, which, had been subjected to the initial charge and. discharge, were each subjected to three cycles of charge and discharge at 55° C. The three cycles of the charge and discharge were carried out with respect, to a first battery at a constant charge, electric current value of 1 C and a constant discharge electric current value of 0.2 C, and the three cycles of the charge and discharge were carried out with respect to a second battery, which is different from the first battery but identical in structure to the first battery, at a constant charge electric current value of 1 C and a constant discharge electric current, value of 20 C. Then, a ratio between (a) a discharge capacity in the third cycle where the discharge electric current value was 20 C and (b) a discharge capacity in the third cycle where the discharge electric current value was 0.2 C (20 C discharge capacity/0.2 C discharge capacity) was calculated as an initial rate characteristic.

### (3) Rate Characteristic Maintaining Ratio After Charge and Discharge Cycle

The nonaqueous electrolyte secondary batteries, which had been subjected to the measurement of the initial rate characteristic, were each subjected to 100 cycles of charge and discharge. Each of the 100 cycles of the charge and discharge was carried out at 55° C., at a voltage ranging from 4.2 V to 2.7 V, and at a constant, charge electric current value of 1 C and a constant discharge electric current value of 10 C.

The nonaqueous electrolyte secondary batteries, which had been subjected to the 100 cycles of the charge and discharge, were each subjected to three cycles of charge and discharge at 55° C. The three cycles of the charge and discharge were carried out with respect to a first battery at a constant charge electric current value of 1 C and a constant discharge electric current value of 0.2 C, and the three cycles of the charge and discharge were carried out with respect to a second battery, which is different from the first battery but identical in structure to the first battery, at a constant charge electric current value of 1 C and a constant discharge electric current value of 20 C. Then, a ratio between (a) a discharge capacity in the third cycle where the discharge electric current value was 20 C and (b) a discharge capacity in the third cycle where the discharge electric current value was 0.2 C (20 C discharge capacity/0.2 C discharge capacity) was calculated as a rate characteristic obtained after the 100 cycles of the charge and discharge had been carried out (rate characteristic after 100 cycles).

A rate characteristic maintaining ratio (%) before and after a charge and discharge cycle was calculated in accordance with the results of the above tests for the rate characteristic and based on the following equation:

Rate characteristic maintaining ratio=(rate characteristic after 100 cycles)/(initial rate characteristic)×100

### Preparation of Nonaqueous Electrolyte Secondary Battery Separator

Porous films in accordance with Examples 1 through 4 and Comparative Examples 2 and 3, each of which porous films is to be used as a nonaqueous electrolyte secondary battery separator, were prepared as below.

### Example 1

First, 68% by weight of an ultra-high molecular weight polyethylene powder (GUR2024, manufactured by Ticona) and 32% by weight of a polyethylene wax (FNP-0115, manufactured by Nippon Seiro Co., Ltd.) that had a weight-average molecular weight of 1000 were prepared, i.e., 100 parts by weight in total of the ultra-high molecular weight polyethylene and the polyethylene wax were prepared. Then, 0.4% by weight of an antioxidant (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax, and then calcium carbonate (manufactured by Maruo Calcium Co., Ltd.) having an average particle size of 0.1 μm was further added by 38% by volume with respect to a total volume of these compounds. Then, these compounds were mixed in a state of powder by a Henschel mixer, and were then melted and kneaded by a twin screw kneading extruder, and thus a polyolefin resin composition was obtained. Then, the polyolefin resin composition was rolled by a pair of rollers having a surface temperature of 150° C., so that a sheet was produced. The sheet thus produced was immersed in a hydrochloric acid aqueous solution (4 mol/L of hydrochloric acid, 0.5% by weight of a nonionic surfactant), so that calcium carbonate was removed. Then, the sheet was stretched at a stretching ratio of 6.2 times, a temperature of 100° C. to 105° C., and a strain rate of 1250% per minute to obtain a film having a thickness of 10.9 μm, Further, the film was subjected to a heat fixation process at 126° C., so that the nonaqueous electrolyte secondary battery separator of Example 1 was obtained.

### Example 2

First, 70% by weight of an ultra-high molecular weight polyethylene powder (GUR4032, manufactured by Ticona) and 30% by weight of a polyethylene wax (FNP-0115; manufactured by Nippon Seiro Co., Ltd.) that had a weight-average molecular weight of 1000 were prepared, i.e., 100 parts by weight in total of the ultra-high molecular weight polyethylene and the polyethylene wax were prepared. Then, 0.4% by weight, of an antioxidant (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax, and then calcium carbonate (manufactured by Maruo Calcium Co., Ltd.) having an average particle size of 0.1 μm was further added by 36% by volume with respect to a total volume of these compounds. Then, these compounds were mixed in a state of powder by a Henschel mixer, and were then melted and kneaded by a twin screw kneading extruder, and thus a polyolefin resin composition was obtained. Then, the polyolefin resin composition was rolled by a pair of rollers having a surface temperature of 150° C. so that a sheet was produced. The sheet thus produced was immersed in a hydrochloric acid aqueous solution (4 mol/L of hydrochloric acid, 0.5% by weight of a nonionic surfactant), so that calcium carbonate was removed. Then, the sheet was stretched at a stretching ratio of 6.2 times, a temperature of 100° C. to 105° C., and a strain rate of 1250% per minute to obtain a film having a thickness of 15.5 μm. Further, the film was subjected to a heat fixation process at 120° C. so that the nonaqueous electrolyte secondary battery separator of Example 2 was obtained.

### Example 3

First, 71% by weight of an ultra-high molecular weight polyethylene powder (GUR4032, manufactured by Ticona) and 29% by weight of a polyethylene wax (FNP-0115; manufactured by Nippon Seiro Co., Ltd,) that had a weight-average molecular weight of 1000 were prepared, i.e., 100 parts by weight in total of the ultra-high molecular weight polyethylene and the polyethylene wax were prepared. Then, 0.4% by weight of an antioxidant (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax, and then calcium carbonate (manufactured by Maruo Calcium Co., Ltd.) having an average particle size of 0.1 μm was further added by 37% by volume with respect to a total volume of these compounds. Then, these compounds were mixed in a state of powder by a Henschel mixer, and were their melted and kneaded by a twin screw kneading extruder, and thus a polyolefin resin composition was obtained. Then, the polyolefin resin composition was rolled by a. pair of rollers having a surface temperature of 150° C. so that a sheet was produced. The sheet thus produced was immersed in a hydrochloric acid aqueous solution (4 mol/L of hydrochloric acid, 0.5% by weight of a nonionic surfactant), so that calcium carbonate was removed. Then, the sheet was stretched at a stretching ratio of 7.0 times, a temperature of 100° C. to 105° C., and a strain rate of 2100% per minute to obtain a film having a thickness of 11.7 μm. Further, the film was subjected to a heat fixation process at 123° C. so that the nonaqueous electrolyte secondary battery separator of Example 3 was obtained.

### Example 4

First, 70% by weight of an ultra-high molecular weight polyethylene powder (GUR4032, manufactured by Ticona) and 30% by weight of a polyethylene wax (FNP-0115; manufactured by Nippon Seiro Co., Ltd.) that had a weight-average molecular weight of 1000 were prepared, i.e., 100 parts by weight in total of the ultra-high molecular weight polyethylene and the polyethylene wax were prepared. Then, 0.4% by weight, of an antioxidant (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax, and then calcium carbonate (manufactured by Maruo Calcium Co., Ltd.) having an average particle size of 0.1 μm was further added by 36% by volume with respect to a total volume of these compounds. Then, these compounds were mixed in a state of powder by a Henschel mixer, and were then melted and kneaded by a twin screw kneading extruder, and thus a polyolefin resin composition was obtained. Then, the polyolefin resin composition was rolled by a pair of rollers having a surface temperature of 150° C. so that a sheet was produced. The sheet, thus produced was immersed in a hydrochloric acid aqueous solution (4 mol/L of hydrochloric acid, 0.5% by weight of a nonionic surfactant), so that calcium carbonate was removed. Then, the sheet was stretched at a stretching ratio of 6.2 times, a temperature of 100° C. to 105° C., and a strain rate of 750% per minute to obtain a film having a thickness of 16.3 μm. Further, the film was subjected to a heat fixation process at 115° C. so that the nonaqueous electrolyte secondary battery separator of Example 4 was obtained.

### Comparative Example 1

A commercially available polyolefin porous film (olefin separator) was used as the nonaqueous electrolyte secondary battery separator of Comparative Example 1.

### Comparative Example 2

First, 70% by weight of an ultra-high molecular weight polyethylene powder (GUR4032, manufactured by Ticona) and 30% by weight of a polyethylene wax (FNP-0115; manufactured by Nippon Seiro Co., Ltd.) that had a weight-average molecular weight of 1000 were prepared, i.e., 100 parts by weight in total of the ultra-high molecular weight polyethylene and the polyethylene wax were prepared. Then, 0.4% by weight of an antioxidant. (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax, and then calcium carbonate (manufactured by Maruo Calcium Co., Ltd.) having an average particle size of 0.1 μm was further added by 36% by volume with respect to a total volume of these compounds. Then, these compounds were mixed in a state of powder by a Henschel mixer, and were then melted and kneaded by a twin screw kneading extruder, and thus a polyolefin resin composition was obtained. Then, the polyolefin resin composition was rolled by a pair of rollers having a surface temperature of 150° C. so that a sheet was produced. The sheet thus produced was immersed in a hydrochloric acid aqueous solution (4 mol/L of hydrochloric acid, 0.5% by weight of a nonionic surfactant), so that calcium carbonate was removed. Then, the sheet was stretched at a stretching ratio of 6.2 times, a temperature of 100° C. to 105° C., and a strain rate of 2000% per minute to obtain a film having a thickness of 16.3 μm. Further, the film was subjected to a heat fixation process at 123° C. so that the nonaqueous electrolyte secondary battery separator of Comparative Example 2 was obtained.

### Comparative Example 3

First, 71% by weight of an ultra-high molecular weight polyethylene powder (GUR4032, manufactured by Ticona) and 29% by weight of a polyethylene wax (FNP-0115; manufactured by Nippon Seiro Co., Ltd.) that had a weight-average molecular weight of 1000 were prepared, i.e., 100 parts by weight in total of the ultra-high molecular weight polyethylene and the polyethylene wax were prepared. Then, 0.4% by weight of an antioxidant (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax, and then calcium carbonate (manufactured by Maruo Calcium Co., Ltd.) having an average particle size of 0.1 μm was further added by 37% by volume with respect to a total volume of these compounds. Then, these compounds were mixed in a state of powder by a Henschel mixer, and were then melted and kneaded by a twin screw kneading extruder, and thus a polyolefin resin composition was obtained. Then, the polyolefin resin composition was rolled by a pair of rollers having a surface temperature of 150° C. so that a sheet was produced. The sheet thus produced was immersed in a hydrochloric acid aqueous solution (4 mol/L of hydrochloric acid, 0.5% by weight of a nonionic surfactant), so that calcium carbonate was removed. Then, the sheet was stretched at a stretching ratio of 7.1 times, a temperature of 100° C. to 105° C., and a strain rate of 750% per minute to obtain a film having a thickness of 11.5 μm. Further, the film was subjected to a heat fixation process at 128° C. so that the nonaqueous electrolyte secondary battery separator of Comparative Example 3 was obtained.

Table 1 below shows a stretching strain rate, a stretched film, thickness, a heat fixation temperature, and a heat fixation temperature/stretched film thickness (heat fixation temperature per unit thickness of stretched film) of each of Examples 1 through 4 and Comparative Examples 2 and 3.

TABLE 1

| | Stretching | Stretched | Heat | Heat fixation |
|---|---|---|---|---|
| | strain | film | fixation | temperature/stretched |
| | rate | thickness | temperature | film thickness |
| | [%/min] | [μm] | [° C.] | [° C./μm] |
| Example 1 | 1250 | 10.9 | 126 | 11.6 |
| Example 2 | 1250 | 15.5 | 120 | 7.7 |
| Example 3 | 2100 | 11.7 | 123 | 10.5 |
| Example 4 | 750 | 16.3 | 115 | 7.1 |
| Comparative | 2000 | 16.3 | 123 | 7.5 |
| Example 2 | | | | |
| Comparative | 750 | 11.5 | 128 | 11.1 |
| Example 3 | | | | |

### Production of Nonaqueous Electrolyte Secondary Battery

Next, nonaqueous secondary batteries were produced as below by using the nonaqueous secondary battery separators of Examples 1 through 4 and Comparative Examples 1 through 3, which were produced as above.

### Cathode

A commercially available cathode which was produced by applying LiNi_{0.5}Mn_{0.3}Co_{0.2}O₂/conductive material/PVDF (weight ratio 92/5/3) to an aluminum foil was used. The aluminum foil of the cathode was cut so that a portion of the cathode where a cathode active material layer was formed had a size of 45 mm×30 mm and a portion where the cathode active material layer was not formed, with a width of 13 mm, remained around that portion. The cathode active material layer had a thickness of 58 μm and density of 2.50 g/cm³. The cathode had a capacity of 174 mAh/g.

### Anode

A commercially available anode produced by applying graphite/styrene-1,3-butadiene copolymer/carboxymethyl cellulose sodium (weight ratio 98/1/1) to a copper foil was used. The copper foil of the anode was cut so that a portion of the anode where an anode active material layer was formed had a size of 50 mm×35 mm, and a portion where the anode active material layer was not formed, with a width of 13 mm, remained around that portion. The anode active material layer had a thickness of 49 μm and density of 1.40 g/cm³. The anode had a capacity of 372 mAh/g.

### Assembly

In a laminate pouch, the cathode, the nonaqueous secondary battery separator, and the anode were laminated (provided) in this order so as to obtain a nonaqueous electrolyte secondary battery member. In this case, the cathode and the anode were positioned so that a whole of a main surface of the cathode active material layer of the cathode was included in a range of a main surface (overlapped the main surface) of the anode active material layer of the anode.

Subsequently, the nonaqueous electrolyte secondary battery member was put in a bag made by laminating an aluminum layer and a heat seal layer, and 0.2 5 ml of a nonaqueous electrolyte solution was poured into the bag. The nonaqueous electrolyte solution was an electrolyte solution at 25° C. obtained by dissolving LiPF₆, with a concentration of 1.0 mole per liter in a mixed solvent of ethyl methyl carbonate, diethyl carbonate, and ethylene carbonate in a volume ratio of 50:20:30. The bag was heat-sealed while a pressure inside the bag was reduced, so that a nonaqueous secondary battery was produced. The nonaqueous electrolyte secondary battery had a design capacity of 20.5 mAh.

### Results of Measurement of Various Physical Properties

Table 2 shows the results of measurement of various physical properties for each of the nonaqueous electrolyte secondary battery separators of Examples 1 through 4 and Comparative Examples 1 through 3.

TABLE 2

| | | | Time until |
|---|---|---|---|
| | | | temperature rise |
| | | Time until | cessation/mass |
| | Mass per unit | temperature rise | per unit area |
| | area (g/m²) | cessation (sec) | (sec · m²/g) |
| Example 1 | 6.4 | 19.8 | 3.09 |
| Example 2 | 6.9 | 20.6 | 2.99 |
| Example 3 | 5.4 | 28.4 | 5.26 |
| Example 4 | 5.3 | 29.8 | 5.62 |
| Cormparative | 13.9 | 26.6 | 1.91 |
| Example 1 | | | |
| Comparative | 9.6 | 25.8 | 2.69 |
| Example 2 | | | |
| Comparative | 6.2 | 17.8 | 2.88 |
| Example 3 | | | |
| | | | Rate |
| | | Rate | characteristic |
| | Initial rate | characteristic | maintaining ratio |
| | characteristic | after 100 cycles | (%) |
| Example 1 | 0.597 | 0.374 | 63 |
| Example 2 | 0.771 | 0.523 | 68 |
| Example 3 | 0.784 | 0.555 | 71 |
| Example 4 | 0.840 | 0.493 | 59 |
| Comparative | 0.482 | 0.177 | 37 |
| Example 1 | | | |
| Comparative | 0.141 | 0.127 | 90 |
| Example 2 | | | |
| Comparative | 0.691 | 0.358 | 52 |
| Example 3 | | | |

As shown in Table 2, the nonaqueous electrolyte secondary battery separators of Examples 1 through 4, each of which nonaqueous electrolyte secondary battery separators has a time until temperature rise cessation with respect to an amount of resin per unit area (mass per unit area) of 2.9 sec·m²/g to 5.7 sec·m²/g, each have an excellent initial rate characteristic and make it possible to prevent a fall in rate characteristic maintaining ratio. This reveals that Examples 1 through 4 are more excellent than Comparative Examples 1 through 3, in each of which a time until temperature rise cessation with respect to mass per unit area is outside the range of 2.9 sec·m²/g to 5.7 sec·m²/g.

1. A nonaqueous electrolyte secondary battery separator comprising a porous film containing not less than 50% by volume of polyolefin,
the nonaqueous electrolyte secondary battery separator having a time until temperature rise cessation with respect to an amount of resin per unit area of 2.9 sec·m²/g to 5.7 sec·m²/g, the time being obtained in a case where the nonaqueous electrolyte secondary battery separator is impregnated with N-methylpyrrolidone containing 3 wt % water and is subsequently irradiated, at an output of 1,800 W, with a microwave having a frequency of 2,455 MHz.

2. The nonaqueous electrolyte secondary battery separator as set forth in claim 1, wherein the time until temperature rise cessation with respect to an amount of resin per unit area ranges from 2.9 sec·m²/g to 5.3 sec·m²/g.

3. A nonaqueous electrolyte secondary battery laminated separator comprising:
a nonaqueous electrolyte secondary battery separator recited in claim 1; and
a porous layer.

4. A nonaqueous electrolyte secondary battery laminated separator comprising:
a nonaqueous electrolyte secondary battery separator recited in claim 2; and
a porous layer.

5. A nonaqueous electrolyte secondary battery member comprising:
a cathode;
a nonaqueous electrolyte secondary battery separator recited in claim 1; and
an anode,
the cathode, the nonaqueous electrolyte secondary battery separator, and the anode being provided in this order.

6. A nonaqueous electrolyte secondary battery member comprising:
a cathode;
a nonaqueous electrolyte secondary battery separator recited in claim 2; and
an anode,
the cathode, the nonaqueous electrolyte secondary battery separator, and the anode being provided in this order.

7. A nonaqueous electrolyte secondary battery member comprising:
a cathode;
a nonaqueous electrolyte secondary battery laminated separator recited in claim 3; and
an anode,
the cathode, the nonaqueous electrolyte secondary battery laminated separator, and the anode being provided in this order.

8. A nonaqueous electrolyte secondary battery member comprising:
a cathode;
a nonaqueous electrolyte secondary battery laminated separator recited in claim 4; and
an anode,
the cathode, the nonaqueous electrolyte secondary battery laminated separator, and the anode being provided in this order.

9. A nonaqueous electrolyte secondary battery comprising a nonaqueous electrolyte secondary battery separator recited in claim 1.

10. A nonaqueous electrolyte secondary battery comprising a nonaqueous electrolyte secondary battery separator recited in claim 2.

11. A nonaqueous electrolyte secondary battery comprising a nonaqueous electrolyte secondary battery laminated separator recited in claim 3.

12. A nonaqueous electrolyte secondary battery comprising a nonaqueous electrolyte secondary battery laminated separator recited in claim 4.
